(19) United States
(12) Patent Application Publication
(10) Pub. No.: US 2025/0069043 A1
(43) Pub. Date: Feb. 27, 2025

(54) APPARATUS AND METHOD FOR ISSUANCE OF MEETING INVITATIONS

(71) Applicant: CANON U.S.A., INC., MELVILLE, NY (US)

(72) Inventor: Shingo Murata, Mineola, NY (US)

(21) Appl. No.: 18/719,118

(22) PCT Filed: Dec. 13, 2022
(86) PCT No.: PCT/US2022/081430

§ 371 Date: Jun. 12, 2024

Related U.S. Application Data
(60) Provisional application No. 63/289,527, filed on Dec. 14, 2021.

(51) Int. Cl. G06Q 10/1093; G06V 40/16; G06V 40/20

(52) U.S. Cl. CPC G06Q 10/1095; G06V 40/161; G06V 40/28

(57) ABSTRACT

An apparatus and control method is provided and controls the issuance of a meeting invitation for an online meeting which allows for meetings to be established and initiated more smoothly. Accordingly the apparatus and method includes receiving a captured video from a camera capturing a meeting room, detecting one or more face regions from the captured video of the meeting room, searching for email addresses corresponding to each of the one or more face regions, obtaining time information regarding the online meeting to be held, and performing control for sending a meeting invitation created based on the time information regarding the online meeting to email addresses corresponding to each of the one or more face regions detected from the captured video of the meeting room.

### CROSS-REFERENCE TO RELATED APPLICATIONS

This application claims the benefit of priority from U.S. Provisional Patent Application Ser. No. 63/289,527 filed on Dec. 14, 2021, the entirety of which is incorporated herein by reference.

### BACKGROUND

### Field

The disclosure relates to a meeting invitation for an online meeting.

### Description of Related Art

Online meeting services such as Teams, Zoom, and Skype are known. When an online meeting is going to be conducted using such services, an organizer is required to generate and send a meeting invitation to each member who is expected to be joined. The members who receive the invitation will access the URL included in the invitation to join the online meeting. A problem associated with this relates to generating and sending meeting invitations which may impact the smooth execution of an online meeting. For example, when an online meeting which has not been scheduled is needed to be started, the start of the online meeting may be delayed by a time for generating and sending a meeting invitation. A system and method according to the present disclosure remedies the drawbacks identified above.

### SUMMARY

An apparatus and control method according to the present disclosure advantageously provides for controlling the issuance of a meeting invitation for an online meeting which allows for meetings to be established and initiated more smoothly. Accordingly the apparatus and method includes receiving a captured video from a camera capturing a meeting room, detecting one or more face regions from the captured video of the meeting room, searching for email addresses corresponding to each of the one or more face regions, obtaining time information regarding the online meeting to be held, and performing control for sending a meeting invitation created based on the time information regarding the online meeting to email addresses corresponding to each of the one or more face regions detected from the captured video of the meeting room.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates the system architecture of the present disclosure.

FIG. 2 illustrates an algorithm for performing exemplary operations of the present disclosure.

FIG. 3A illustrates an algorithm of one or more aspects illustrated in FIG. 2.

FIG. 3B illustrates an algorithm of one or more aspects illustrated in FIG. 2.

FIG. 4A illustrates algorithm of one or more aspects illustrated in FIG. 2.

FIG. 4B illustrates an algorithm of one or more aspects illustrated in FIG. 2.

FIG. 5 illustrates the hardware configuration according to the present disclosure.

FIG. 6 illustrates a face recognition process according the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

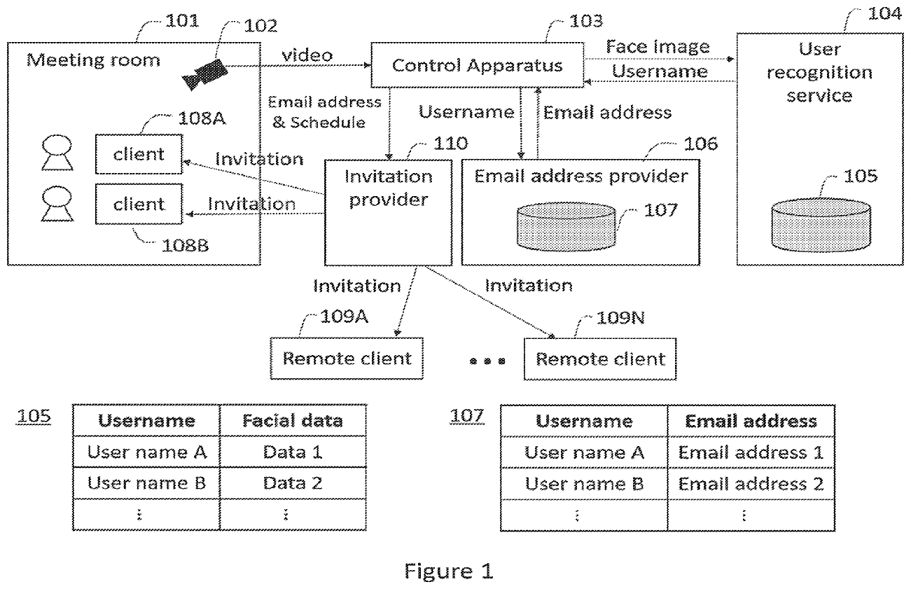

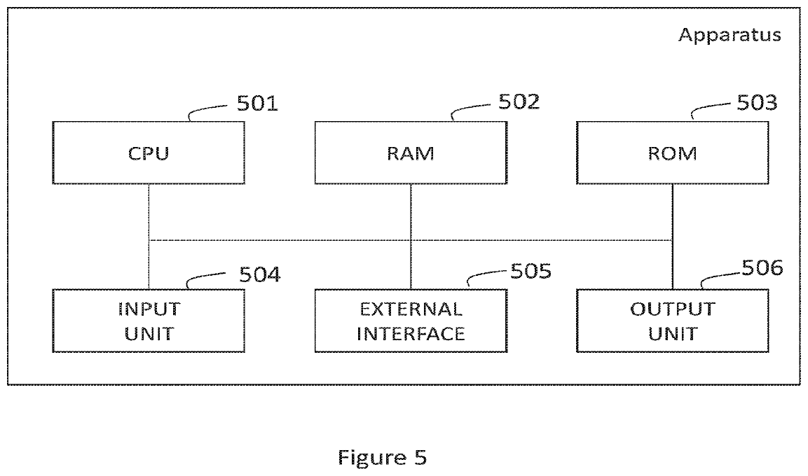

FIG. 1 illustrates a system architecture according to an exemplary embodiment. The system includes a camera 102, a control apparatus 103, a user recognition service 104, a database 105, an email address provider 106, a database 107, client computer 10A and 108B (when referred to generically in the description, the client computer will be denoted by reference numeral 108), one or more remote client computers 109A-N(when referred to generically in the description, the remote client will be denoted by reference numeral 109) and an invitation provider 110. In this embodiment, the camera 102, the control apparatus 103 and the client computer 108 may be located in a meeting room 101 but this is not seen to be limiting. Note that FIG. 1 shows that each of the camera 102, the control apparatus 103, the user recognition service 104 and the email address provider 106 is implemented in a different computer shown in FIG. 5 but it's not seen to be limiting. For example, the control apparatus 103 may be able to work as the user recognition service 104 and/or the invitation provider 110.

In an exemplary embodiment, the client computer 108 and the remote client computer 109 executes the same computer program for an online meeting. However, the client computer 108 and the remote client computer 109 are described by a different name according to whether the computer is located in the meeting room 101 or not, for explanation purpose.

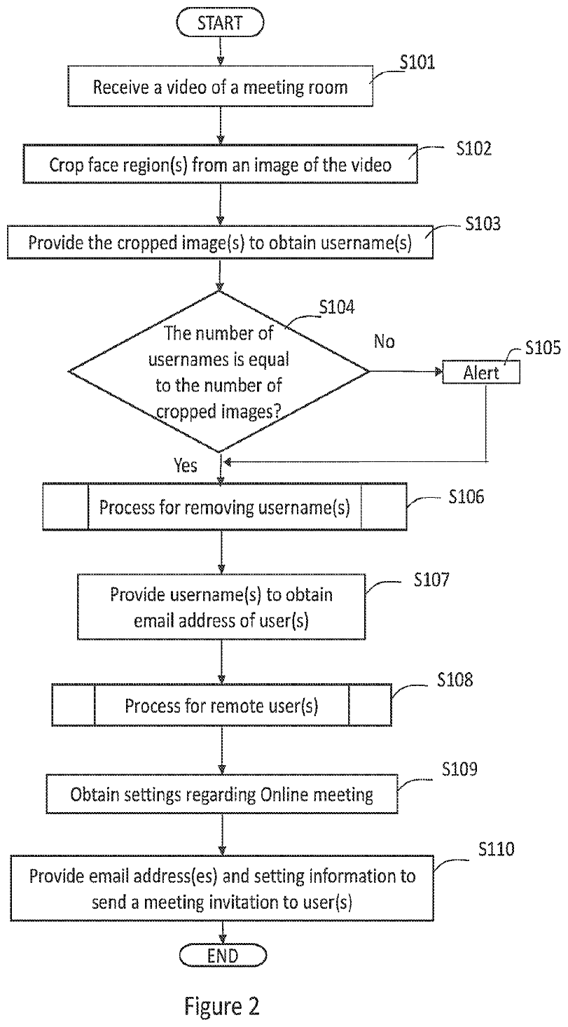

FIG. 2 is a flow chart illustrating an operation of the control apparatus 103 according to an exemplary embodiment. The operation of the control apparatus 103 according to an exemplary embodiment will be described in detail below with reference to FIG. 1 and FIG. 2. The operation described with reference to FIG. 2 will be started in response to a trigger that the control apparatus 103 detects a predetermined gesture for starting an online meeting from a video captured by the camera 102. In one embodiment, the predetermined gestures is a hand gesture whereby a particular hand configuration is performed and captured by the camera 102. However, this is not seen to be limiting. For example, the operation reference to FIG. 2 may be started by a voice control, keyboard operations or mouse operations by a user of the control apparatus 103. For example, the control apparatus 103 may cause a user interface to be generated and displayed on a display device whereby a user may actively select one or more image elements displayed on the user interface that would cause an online meeting to begin. Also, each of the steps described with reference to FIG. 2 is realized by one or more processors (CPU 501) of the control apparatus 103 reading and executing instructions embodied as a pre-determined program stored in a memory (ROM 503).

In S101, The control apparatus 103 obtains, from the camera 102, a captured video of the meeting room 101. The camera 102 is set in the Meeting room 101, performs capturing in the Meeting room 101, and transmits the captured video to the control apparatus 103. The field of view of the captured video may contain each attendee, one or more white boards and/or one or more projection screens located in the meeting room 101.

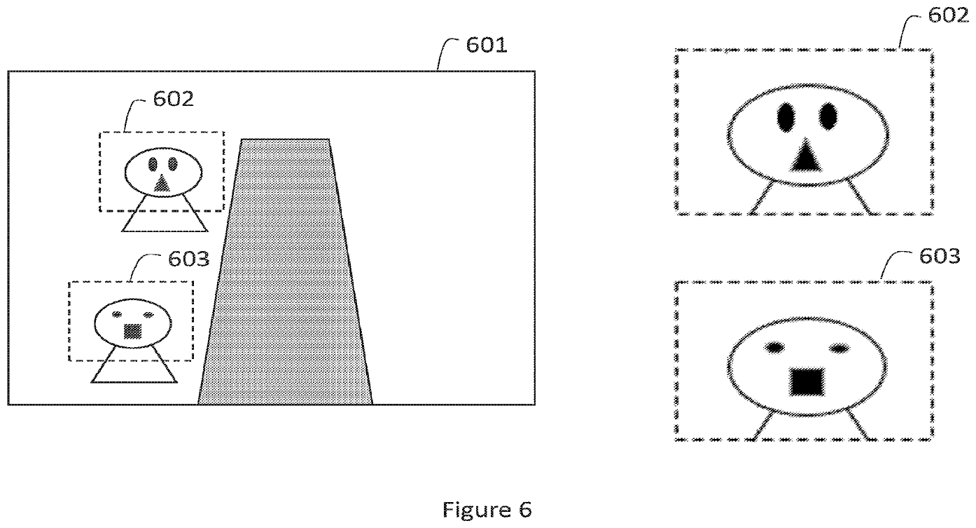

In S102, The control apparatus 103 performs detection process for detecting a face region from the captured video. More specifically, the control apparatus 103 identifies one or more images from among a plurality of images constituting the captured video, and perform face detection process on the identified image(s). As illustrated in FIG. 1, there are two people in the meeting room 101, so two face regions are detected in S102. The control apparatus 103 crops two face regions from the identified image(s). In an exemplary embodiment, as illustrated in FIG. 6, the control apparatus 103 detects a face regions 602 and 603 from an image 601 that represents a captured image the meeting room 10. The control apparatus 103 uses the pixel boundaries identified as part of the detection processing and crops those regions 602 and 603 as illustrated in the right side of FIG. 6. In another embodiment, the face detection processing may be performed by the camera 102, directly, whereby the image captured by the camera 102 is analyzed to determine regions of the captured image that contains one or more faces and may be able to perform the face detection process instead of the control apparatus 103.

In S103, the control apparatus 103 transmits data representing each of the cropped face regions 602 and 603 (face images) to the user recognition service 104 to obtain Usernames corresponding to the two face region. The user recognition service 104 comprises the database 105 which stores Facial data and Username associated with each other. In one embodiment, the facial data may be previously captured data of a particular user's face obtained during a precapture process whereby the user logs in and provides a user name which is then associated with the face data being captured. In another embodiment, facial data represents an anonymized version of the users face whereby actual facial images are not stored but rather indicators or landmarks or other identifying features are stored as facial data which is then associated with a given user name. The user recognition service 104 is able to compare the face images received from the control apparatus 103 with Facial data in the database 105 to identify the Username corresponding to the face region detected from the video. The identified username is provided from the user recognition service 104 to the control apparatus 103.

In S104, the control apparatus 103 determines whether the number of face regions detected in S102 is equal to the number of Usernames obtained in S103. If it's not equal, flow proceeds to S105 and if it's equal, flow proceeds to S106.

In S105, the control apparatus 103 outputs an alert. For example, the message “Failure to identify Username” is displayed on a display screen which is in the meeting room 101 and is connected to the control apparatus 103 if the number of face regions is greater than the number of usernames. As another example, the message “Greater number of Usernames are identified than the number of people in the meeting room” is displayed if the number of face region is less than the number of usernames. The alert may be displaying an alert message and/or outputting an alert sound.

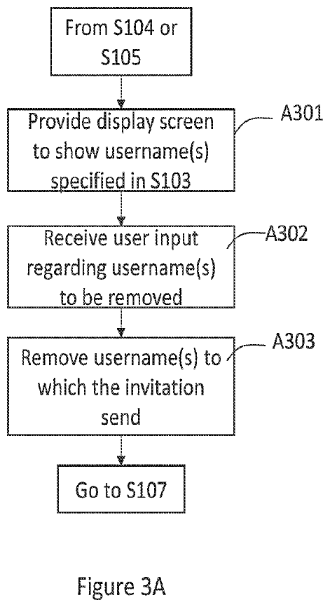

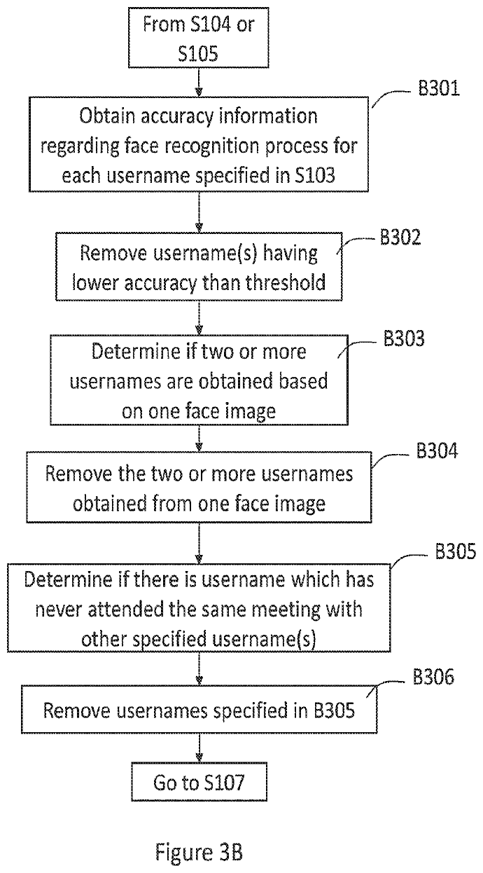

In S106, the control apparatus 103 performs removal process for removing one or more usernames among the usernames identified in S103 from a list of candidate recipients that are to receive an online meeting invitation. More detailed explanation will be provided with reference to FIGS. 3A and 3B later.

In S107, the control apparatus 103 transmits one or more usernames to the email address provider 106 to obtain email addresses corresponding to the one or more usernames. The email address provider 106 comprises the database 107 which stores Usernames and Email addresses associated with each other, and the email address provider 106 is able to compare each of the one or more usernames received from the control apparatus 103 with usernames in the database 107 to identify the Email address corresponding to the username. In the example of FIG. 1, there are two people in the meeting room 101, so two usernames are identified in S103 and two email addresses are identified in S107. The identified email address is provided from the email address provider 106 to the control apparatus 103. In an exemplary embodiment, the databases 105 and 107 are separated with each other but this is not seen to be limiting. As another example, the user recognition service 104 and the email address provider 106 may refer the same database containing the username, the facial data and the email address associated with each other.

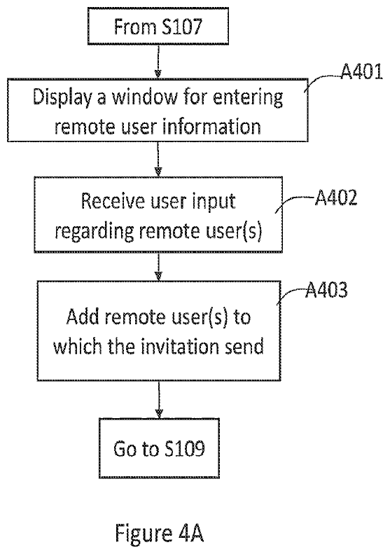

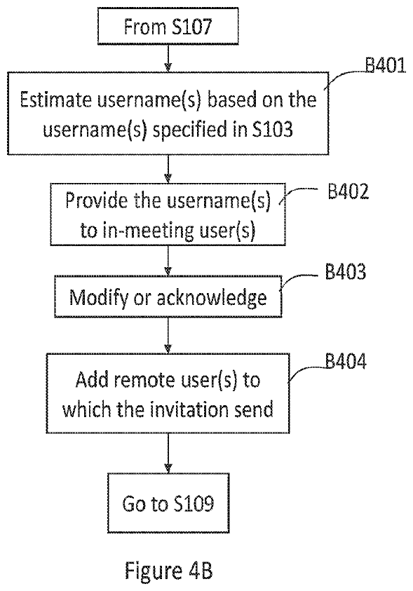

In S108, the control apparatus 103 performs identify processing for identifying one or more remote users to be invited into the online meeting. More detailed explanation will be provided with reference to FIGS. 4A and 4B later. In S109, the control apparatus 103 obtains setting information regarding the online meeting. The setting information may contain, for example, a start time, an end time and/or a time duration of the online meeting. The start time of the online meeting may be a time when the predetermined gesture for starting the online meeting is performed and detected. The time duration may be a predetermined time period (e.g. 1 hour) and the user may be able to preset an arbitrary length of time. The control apparatus 103 may be able to determine the time duration information depending on the identified username. For e

In S110, The control apparatus 103 provides, to the invitation provider 110, the email addresses identified in S107 and S108 and the setting information obtained in S109. The invitation provider 110 creates the online meeting invitation based on the setting information from the control apparatus 103 and communicates the invitation to the respective recipients using the obtained email addresses. The online meeting invitation may contain at least one of the start time, the end time, the time duration of the online meeting and/or the URL for participating the online meeting.

The client computer 108 and the remote client computer 109 which receive the online meeting invitation display the online meeting invitation on its display screen. After that, for example, if a user of the client computer 108 indicates “Accept” to participate in the online meeting invitation, the client computer 108 starts to display the captured video of the meeting room 101 that is received from the camera 102. On the other hand, if a user of the client computer 108 indicates “Decline” to the online meeting invitation, the client computer 108 does not display the captured video of the meeting room 101. This configuration has an advantage in the security aspect but it's not essential to perform this control.

The detailed operation of S106 in FIG. 2 according to an exemplary embodiment will be described below with reference to FIGS. 3A and 3B. FIG. 3A illustrates an operation for showing Usernames identified in S103 to a user in the meeting room 101 to enable the user to delete one or more usernames. In A301, the control apparatus 103 controls a display screen to display Usernames identified in S103 and waits for user operations regarding removal of one or more usernames. When the control apparatus 103 receives a signal according to the user operations regarding removal of the one or more usernames in A302, the control apparatus 103 removes the one or more usernames from recipients of an online meeting invitation in A303 and flow proceeds to S107. The user operations may be performed by gesture operations, keyboard operations and/or mouse operations by a user of the control apparatus 103. The control apparatus 103 does not remove any usernames if the control apparatus 103 does not receive the signal according to the user operations regarding removal of the usernames for a predetermined length of time (e.g. 3 seconds) from displaying the usernames on the display screen, and flow proceeds to S107.

FIG. 3B illustrates an operation for automatically determining Usernames to remove from among the usernames identified in S103. In B301, the control apparatus 103 obtains, from the user recognition service 104, accuracy information regarding identification process of the username. The accuracy information represents a degree of similarity between the facial data stored in the database 105 and the face image that is provided from the control apparatus 103 to the user recognition service 104. In an exemplary embodiment, the accuracy information has a range between 0-100 and the higher value represents the higher accuracy.

In B302, the control apparatus 103 determines, based on the accuracy information obtained in B301, one or more usernames to remove from recipients of the online meeting invitation. For example, the control apparatus 103 identifies Usernames A and B in S103, the accuracy information for username A indicates “90”, the accuracy information for username B indicates “70” and a predetermined threshold value is “80”, then the control apparatus 103 determines that username B should be removed from recipients of the online meeting invitation. If all accuracy information of all of the usernames are equal or higher than the threshold value, the control apparatus 103 determines any usernames should not be removed in this step. In B303, the control apparatus 103 determines if two or more usernames is identified from image data of one face region. In B304, the control apparatus 103 determines, based on the result of B303, one or more usernames to remove from recipients of the online meeting invitation. For example, the control apparatus 103 may determine to remove two or more usernames corresponding to one face region from recipients of the online meeting invitation. As another example, the control apparatus may determine to remain one username having accuracy information indicating the highest accuracy among the two or more usernames corresponding to one face region and determines to remove all other usernames from the recipients of the online meeting invitation.

In B305, the control apparatus 103 may identify, from among the usernames identified in S103, a username that has never attend an online meeting together with the other usernames. For example, the control apparatus 103 obtains 5 usernames (username A, B, C, D and E), the usernames A, B, D and E have had an online meeting in the past and the username C has never had an online meeting with any other usernames A, B, D and E, then the control apparatus 103 identifies the username C.

The control apparatus 103 may be able to access meeting history information containing date/time and attendee information of each online meeting in the past to identify the username that has never attend an online meeting together with the other usernames. For example, the meeting history information contains (a) Meeting date/time (e.g. 12/30/2021, from 1:00 AM-2:00 AM) and (b) Attendees (e.g. username A and username B) for each online meeting which has been conducted. In this example, when the control apparatus 103 identifies username A, B, C, D and E in S103, the control apparatus 103 accesses the meeting history information to search the username A and identify who has attended a meeting together with username A in the past. If the number of usernames identified among the username B, C, D and E is larger than a threshold number, the control apparatus 103 determines not to remove the username A in B306 from the recipient of the online meeting invitation. In the same way, the control apparatus 103 determines whether each username shall be removed or not.

As another example, the control apparatus 103 may remove all usernames identified in S103 from the recipients of the online meeting invitation thereby the online meeting invitation is not sent in a case where a number of the usernames which have never attended an online meeting together with the other usernames among the usernames identified in S103 is larger than a threshold number.

In an exemplary embodiment, the meeting history information may be stored in a server connected with the control apparatus 103 via a communication network but this is not seen to be limiting. For example, the email address provider 106 may store the meeting history information and the email address provider 106 determines email addresses to provide to the control apparatus 103 such that an email address of a username that has never attended an online meeting together with the other usernames is not provided to the control apparatus 103. As another example, the control apparatus 103 may store the meeting history information in memories implemented in the control apparatus 103.

In B306, the control apparatus 103 removes the usernames identified in B305 from the recipients of the online meeting invitation. Note that it's not necessary to perform all steps from B301-S306. For example, the control apparatus 103 may perform B301 and B302 only or from B303 to B306 only. The control apparatus 103 may skip S106 thereby all of B301-S306 are skipped. Further, the control apparatus 103 may propose the username(s) to be removed to a user of the control apparatus 103 and obtains authorization/acknowledgement from the user before removal.

The detailed operation of S108 in FIG. 2 according to an exemplary embodiment will be described below with reference to FIGS. 4A and 4B. FIG. 4A illustrates an operation for identifying Usernames of remote users to be invited to the online meeting by the user in the meeting room 101. In A401, the control apparatus 103 causes a display screen to display a window to enter information regarding a remote user and wait for user operations. When the control apparatus 103 receives a signal according to the user operations regarding remote users in A402, the control apparatus 103 adds the one or more usernames of the remote user(s) into the recipients of an online meeting invitation in A403 and flow proceeds to S109. The user operations may be performed by gesture operations, keyboard operations and/or mouse operations by the user of the control apparatus 103. The control apparatus 103 does not add any usernames of the remote users if the control apparatus 103 does not receive the signal according to the user operations for a predetermined length of time (e.g. 5 seconds) from displaying the window on the display screen, and flow proceeds to S109.

FIG. 4B illustrates an operation for the control apparatus 103 to estimate Usernames of remote users to be invited to the online meeting. In B401, the control apparatus 103 estimates, based on the usernames identified in S103, one or more usernames to be invited in the online meeting. The control apparatus may refer the meeting history information containing date/time and attendee information of each online meeting in the past to estimate usernames to be invited into the online meeting. The control apparatus may also refer organization information associating each username with a section, a project and/or a team to estimate the one or more usernames to be invited into the online meeting. For example, if usernames A and B whose section is different are identified in S103, a manager of each username A and B may be added as the recipient of the online meeting invitation. As another example, if all team members except for a person who is located in a different office are identified in S103, the person may be added as the recipient of the online meeting invitation. In B402, the control apparatus 103 presents, to the user in the meeting room 101, the one or more usernames identified by the estimation process in B401 as candidates of attendees of the online meeting. More specifically, the control apparatus 103 causes the display screen to display the one or more estimated usernames. In B403, the control apparatus 103 is await for a signal according to user operations regarding modify or acknowledgement of the attendee candidates estimated in B402. In B404, the control apparatus 103 determines, based on the signal according to the user operations received in B403, one or more remote users to be invited into the online meeting and adds the remote users to the recipients of the online meeting invitation. More specifically, in B404, the control apparatus 103 obtains email addresses corresponding to the user names of the remote users from the email address provider 106, and in S110, the online meeting invitation is sent to the email addresses. Note that S108 may be performed before S107.

In an exemplary embodiment, the control apparatus 103 identifies usernames based on the image data of the face regions and identifies email addresses based on the usernames, but this is not seen to be limiting. Instead of the usernames, the control apparatus 103 may be able to use User ID or other information for identifying individual users. The one or more usernames obtained in S103 may be able to be superimposed into the captured video of the meeting room 101. More specifically, the control apparatus 103 transmits a position information (represented by coordinates within the captured region) obtained in S102 and a username obtained in S103 to the Client computer 108 and the remote client computer 109, and the Client computer 108 and the remote client computer 109 who attend the online meeting may display the position information of each face region and the username of each in-room attendee within the captured video of the meeting room 101 by superimposing them into the captured video.

FIG. 5 illustrates the hardware that represents any of the control apparatus 103, the user recognition service 104, the email address provider 106, the client 108, the remote client 109, and/or the invitation provider 110 that can be used in implementing the above described disclosure. The apparatus includes a CPU 501, a RAM 502, a ROM 503, an input unit, an external interface, and an output unit. The CPU 501 controls the apparatus by using a computer program (one or more series of stored instructions executable by the CPU 501) and data stored in the RAM 502 or ROM 503. Here, the apparatus may include one or more dedicated hardware or a graphics processing unit (GPU), which is different from the CPU 501, and the GPU or the dedicated hardware may perform a part of the processes by the CPU 501. As an example of the dedicated hardware, there are an application specific integrated circuit (ASIC), a field-programmable gate array (FPGA), and a digital signal processor (DSP), and the like. The RAM 502 temporarily stores the computer program or data read from the ROM 503, data supplied from outside via the external interface, and the like. The ROM 503 stores the computer program and data which do not need to be modified and which can control the base operation of the apparatus. The input unit is composed of, for example, a joystick, a jog dial, a touch panel, a keyboard, a mouse, or the like, and receives user's operation, and inputs various instructions to the CPU 501. The external interface communicates with external device such as PC, smartphone, camera and the like. The communication with the external devices may be performed by wire using a local area network (LAN) cable, a serial digital interface (SDI) cable, WIFI connection or the like, or may be performed wirelessly via an antenna. The output unit is composed of, for example, a display unit such as a display and a sound output unit such as a speaker, and displays a graphical user interface (GUI) and outputs a guiding sound so that the user can operate the apparatus as needed.

According to the present disclosure and algorithms provided above, a control apparatus for controlling a meeting invitation for an online meeting is provided. The control apparatus advantageously performs facial detection to detect one or more users in a meeting room such that an access link can be generated and provided automatically to those users in the meeting room. This advantageously enables all users to access an online meeting user interface simultaneously. Moreover, the automatic facial detection processing provides the additional advantage of no requiring to know, in advance, who will in meeting room which further delays the beginning of the meeting due to the need to manually add or remove personnel from a meeting invitation. To achieve these advantages, the control apparatus includes one or more processors and one or more memories storing instructions that, when executed, configures the one or more processors of the control apparatus to execute a control method.

As such, the control apparatus receives a captured video from a camera capturing a meeting room and detects one or more face regions from the captured video of the meeting room to search for email addresses corresponding to each of the one or more face regions. In the search processing, the control apparatus identifies, identifying, based on image data corresponding to each of the one or more face regions, usernames corresponding to each of the one or more face regions and searches for the email addresses by using the identified usernames. The image data corresponding to each of the one or more face regions is transmitted to a user recognition server via a communication network and the usernames corresponding to each of the one or more face regions are identified by receiving the usernames from the user recognition server as a response to the image data because the usernames and image data associated with each other.

Time information regarding the online meeting to be held, including but not limited to, at least one of a start time, an end time and a time duration of the online meeting, is obtained and control is performed to send a meeting invitation, including but not limited to invitation at least one of a start time, an end time, a time duration of the online meeting and a URL to attend the online meeting, created based on the time information regarding the online meeting to email addresses corresponding to each of the one or more face regions detected from the captured video of the meeting room. In certain instances, transmitting of the meeting invitation is performed in response to a detection of a predetermined gesture from the captured video from the camera.

The control apparatus is further advantageously configured to perform user name removal processing by remove at least one username among the identified one or more usernames from recipients of the meeting invitation based on certain criteria. The removal processing uses accuracy information regarding identifying process of the usernames received
from the user recognition server whereby a at least one username having the accuracy information indicating an accuracy value lower than a predetermined threshold is removed from the recipient of the meeting invitation. Further, in a case where two or more usernames are received from the user recognition server as the usernames corresponding to one face region, the two or more usernames are removed from the recipient of the meeting invitation thereby preventing the meeting invitation being communicated to an incorrect individual who is not supposed to be able to access the meeting. Additionally, in a case where the usernames received from the user recognition server includes at least one username which has never attended an online meeting together with the other usernames, the at least one username is removed from the recipient of the meeting invitation. This further improves the likelihood that the person being sent the meeting invitation is supposed to receive it due to history information that indicates the users have been in meetings together before as it is more likely that persons who have attended meetings in the past would be in a future meeting to be conducted. In a case where a number of usernames which have never attended an online meeting together with the other usernames among the identified usernames is larger than a threshold number, the identified usernames are removed.

In addition to meeting invitations being sent to users in a meeting room, the control apparatus is further configured to identify email addresses of remote users to be invited to the online meeting transmit the meeting invitation to the email addresses of the remote users. In this instance, the email addresses of the remote users to be invited to the online meeting are identified based on a signal according to manual user operations regarding selection of the remote users. For example, a user interface may be generated and presented to one or more users in the meeting room who manually input email addresses (or otherwise select from a set of candidate meeting attendees) into the meeting invitation being generated. Additionally, the control apparatus can select the email addresses of the remote users to be invited to the online meeting are identified based on the one or more usernames corresponding to the one or more face regions detected from the captured video of the meeting room. For example, if the facial regions detected in the captured video indicate the detected user is “User A”, the database from which that username is obtained, may further include employment hierarchy information associated with User A. More specifically, “User A” may report to “User X” and “User M” and “User N” may report to user A. The control apparatus can automatically determine which of these users is to also be invited. This determination can further be made by comparing titles or position in the company to understand that, if only users of a certain level, are in the meeting room, the control apparatus can select other users related to the recognized user at the same level or at a higher level to be included on the meeting invitation.

The scope of the present disclosure includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A control apparatus for controlling a meeting invitation for an online meeting, the control apparatus comprising:
one or more processors; and
one or more memories storing instructions that, when executed, configures the one or more processors, to:
receive a captured video from a camera capturing a meeting room;
detect one or more face regions from the captured video of the meeting room;
search for email addresses corresponding to each of the one or more face regions,
obtain time information regarding the online meeting to be held; and
perform control for sending a meeting invitation created based on the time information regarding the online meeting to email addresses corresponding to each of the one or more face regions detected from the captured video of the meeting room.

2. The control apparatus according to claim 1, wherein the search comprises:
identifying, based on image data corresponding to each of the one or more face regions, usernames corresponding to each of the one or more face regions, and
searching for the email addresses by using the identified usernames.

3. The control apparatus according to claim 2, wherein
the image data corresponding to each of the one or more face regions is transmitted to a user recognition server via a communication network, and
the usernames corresponding to each of the one or more face regions are identified by receiving the usernames from the user recognition server as a response to the image data,
wherein the user recognition server stores usernames and image data associated with each other.

4. The control apparatus according to claim 3, the instructions further configures the one or more processors to remove at least one username among the identified one or more usernames from recipients of the meeting invitation.

5. The control apparatus according to claim 4, wherein
accuracy information regarding identifying process of the usernames is further received from the user recognition server, the at least one username having the accuracy information indicating an accuracy value lower than a predetermined threshold is removed from the recipient of the meeting invitation.

6. The control apparatus according to claim 4, wherein
in a case where two or more usernames are received from the user recognition server as the usernames corresponding to one face region, the two or more usernames are removed from the recipient of the meeting invitation.

7. The control apparatus according to claim 4, wherein
in a case where the usernames received from the user recognition server includes at least one username which has never attended an online meeting together with the other usernames, the at least one username is removed from the recipient of the meeting invitation.

8. The control apparatus according to claim 4, wherein
in a case where a number of usernames which have never attended an online meeting together with the other usernames among the identified usernames is larger than a threshold number, the identified usernames are removed.

9. The control apparatus according to claim 1, wherein the time information includes at least one of a start time, an end time and a time duration of the online meeting.

10. The control apparatus according to claim 1, the instructions further configures the one or more processors to identify email addresses of remote users to be invited to the online meeting, and perform control to transmit the meeting invitation to the email addresses of the remote users.

11. The control apparatus according to claim 10, wherein the email addresses of the remote users to be invited to the online meeting are identified based on a signal according to manual user operations regarding selection of the remote users.

12. The control apparatus according to claim 10, wherein the email addresses of the remote users to be invited to the online meeting are identified based on the one or more usernames corresponding to the one or more face regions detected from the captured video of the meeting room.

13. The control apparatus according to claim 1, wherein the transmitting of the meeting invitation is performed in response to a detection of a predetermined gesture from the captured video from the camera.

14. The control apparatus according to claim 1, wherein the meeting invitation includes at least one of a start time, an end time, a time duration of the online meeting and a URL to attend the online meeting.

15. A control method for controlling a meeting invitation for an online meeting, the method comprising:
receiving a captured video from a camera capturing a meeting room,
detecting one or more face regions from the captured video of the meeting room;
searching for email addresses corresponding to each of the one or more face regions;
obtaining time information regarding the online meeting to be held; and
performing control for sending a meeting invitation created based on the time information
regarding the online meeting to email addresses corresponding to each of the one or more face regions detected from the captured video of the meeting room.

16. A non-transitory computer-readable storage medium storing one or more programs for causing a computer to execute a control method for including controlling a meeting invitation for an online meeting, the method comprising:
receiving a captured video from a camera capturing a meeting room,
detecting one or more face regions from the captured video of the meeting room;
searching for email addresses corresponding to each of the one or more face regions;
obtaining time information regarding the online meeting to be held; and
performing control for sending a meeting invitation created based on the time information
regarding the online meeting to email addresses corresponding to each of the one or more face regions detected from the captured video of the meeting room.
